(19) United States
(12) Patent Application Publication
(10) Pub. No.: US 2009/0147092 A1
(43) Pub. Date: Jun. 11, 2009

(54) Image capturing system and method for object image of low light intensity

(75) Inventors: Yasunori Nakada, Yokohama-shi (JP); Keiichiro Isihara, Yokohama-shi (JP)

Correspondence Address: BIRCH STEWART KOLASCH & BIRCH, PO BOX 747, FALLS CHURCH, VA, 22040-0747, US

(73) Assignee: Winbond Electronics Corp.

(21) Appl. No.: 12/000,065

(22) Filed: Dec. 7, 2007

(51) Int. Cl. H04N 5/225

(52) U.S. Cl. 348/217.1

(57) ABSTRACT

An image capturing system for capturing an object image of low light intensity comprises an image capturing means, a motion value detection means, a motion value detection means, an image data memory, and a preview image display. The image capturing means outputs a first frame and multiple second frames of object image data. The motion value detection means detects motion values between the first frame and each second frame. The superposition/addition means superposes/adds each second frame to the first frame or a prior superposed/added frame shifting in a reverse direction of the motion value. The image data memory temporally stores image data of the superposed/added frames and sends the image data of a frame superposed/added by a predetermined number of second frames to a predetermined device. The preview image display displays the object image prior to a still image capturing according to the image data of the superposed/added frames.

### BACKGROUND OF THE INVENTION

1. Field of the Invention

This description relates to an image capturing system to capture a low light intensity object image.

2. Description of the Related Art

An image capturing system includes an image sensor, such as a charged coupled device (CCD) sensor or a complementary metal oxide semiconductor (CMOS) sensor, to sense light and generate image data that are processed and stored in a storage medium, such as a flash memory card. Such a typical image sensor is premised on capturing an object image of adequate light intensity, such as more than 1000 Lux. When an object image of low light intensity is captured using the typical image sensor, picture quality of the object image may be significantly deteriorated, because the image sensor cannot generate photo-carriers sufficient to obtain good picture quality image. One method to solve the problem of deterioration of picture quality due to low light intensity is to use a special image sensor dedicated to the purpose, such as an image sensor having photo-carrier multiplication mechanism. However, such a special device is very expensive due to a complex device structure.

Even if digital gain increase process is performed using the typical image sensor to compensate small photo carriers, signal to noise ratio of the object image captured by the image sensor is significantly degraded. In addition, the object image captured by the image sensor becomes blurred due to movement of the camera during long exposure time.

### BRIEF SUMMARY OF THE INVENTION

The present invention provides an image capturing system to capture an object image of low light intensity, which can solve above problems.

An exemplary embodiment of an image capturing system for capturing an object image of low light intensity comprises an image capturing means, a motion value detection means, a superposition/addition means, an image data memory, and a preview image display. The image capturing means outputs a first frame and multiple second frames of object image data. The motion value detection means receives the first frame and the multiple second frames and detects motion values between the first frame and each of the second frames. The superposition/addition means superposes/adds each of the second frames to the first frame or a prior superposed/added frame which shifts in a reverse direction of the motion value. The image data memory temporally stores image data of the superposed/added frames and sends the image data of a frame which is superposed/added by a predetermined number of second frames to a predetermined device. The preview image display displays the object image prior to a still image capturing according to the image data of the superposed/added frames.

An exemplary embodiment of an image capturing method for capturing an object image of low light intensity is provided. First, a first frame and multiple second frames of object image data are generated. Motion values between the first frame and each of the second frames are detected. Each of the second frames is superposed/added to the first frame or a prior superposed/added frame which shifts in a reverse direction of the motion value. Image data of the superposed/added frames is temporally stored. The object image is previewed prior to a still image capturing according to the image data of the superposed/added frames. Final still image data is generated according to the image data of a frame which is superposed/added by a predetermined number of second frames in the still image capturing.

Other features and advantages of the invention are apparent from the following description, and from the claims.

### BRIEF DESCRIPTION OF THE DRAWINGS

The invention can be more fully understood by reading the subsequent detailed description and examples with references made to the accompanying drawings, wherein:

FIG. 1 shows a diagram of an image capturing system to capture an object image of low light intensity according to this invention;

FIG. 2 is a basic flow diagram of superposition/addition operation in the image capturing system according to this invention;

FIG. 3 is an entire operation diagram for operating the image capturing system according to this invention;

FIGS. 4a and 4b show an effect when second image data frame is superposed/added to first image data frame; and

FIGS. 5a and 5b show an example of capturing an object image of ultra low light intensity (5 Lux). FIG. 5a is an image captured by a conventional digital camera adding digital gain increase process. FIG. 5b is image captured by an image capturing system according to this invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

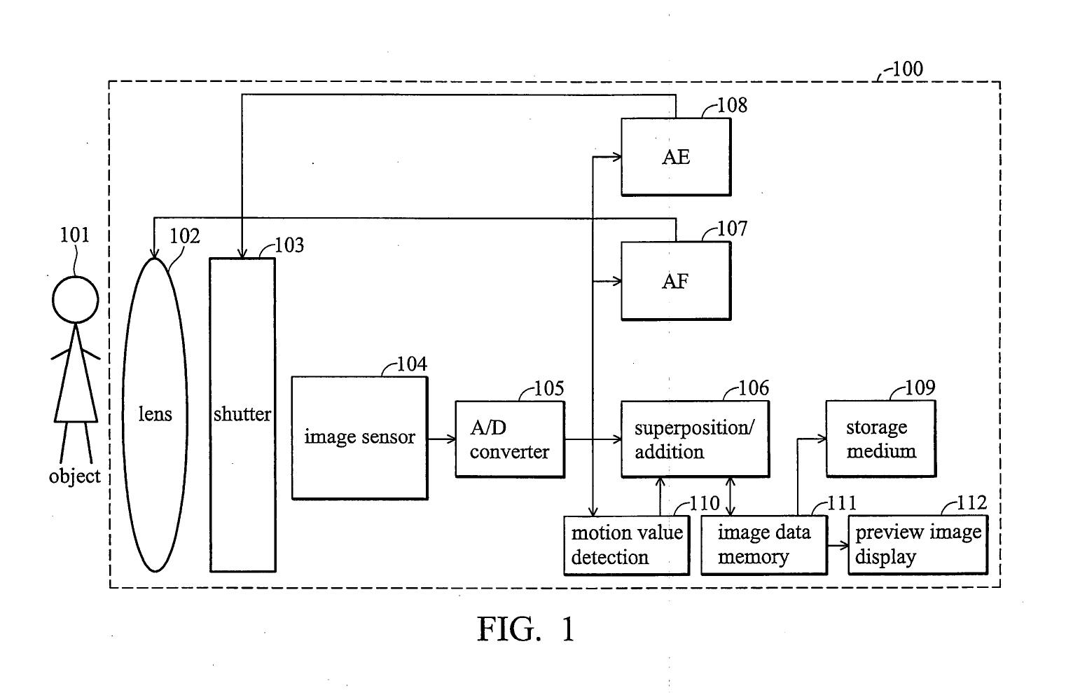

Referring to FIG. 1, an image capturing system 100 according to this invention captures an object image of low light intensity. Here, the low light intensity is defined as smaller light intensity than 500 Lux, which corresponds to light intensity under dim room illumination, where a good picture quality image can not be obtained even using a conventional digital camera.

The image capturing system 100 includes a lens module 102 for focusing an image of a person or an object 101 of the low light intensity onto an image sensor 104 (e.g., a CCD or CMOS sensor). The image sensor 104 includes an array of sensor cells that convert light into analog electrical image data that are converted into digital image data by an analog-to-digital (A/D) converter 105. An auto focus (AF) module 107 moves the lens module 102 to a focus position. An auto exposure (AE) module 108 determines the exposure time based on, among other factors, the intensity of incoming light and the size of an aperture. A shutter 103, controlled by the auto exposure (AE) module 108, determines an exposure time.

The multiple frames of image data captured by the image sensor 104 are sent to the motion value detection block 110, the superposition/addition block 106, the auto focus (AF) module 107 and the auto exposure (AE) module 108. The motion value detection block 110 detects a motion value between a first frame of image data and each second frame of image data subsequent to the first frame of image data using a known method, e.g. an electronic motion value detection method, where detection point is specified on a frame of image data, and a distance and a direction between a detection points on first frame and a detection point on second frame is measured as a motion value. The superposition/addition block 106 superposes/adds each second frame of image data to the first frame of image data or a prior superposed/added frame of image data shifting in reverse direction of the motion value. The image data memory 111 is capable to store at least 2 frames of image data so as to be able to store at least 2 superposed/added frames of image data. The superposed/added frame by predetermined number of second frames of image data are saved as final still image data in a storage medium 109, which can include, e.g., flash memory. Meanwhile, predetermined frames of image data stored in the image data memory 111 are sequentially sent to preview image display 112 where the object image are displayed prior to still image capturing.

In order to achieve a high speed operation, the motion value detection block 110 and the superposition/addition block 106 are configured as a hardware circuit and are integrated on a semiconductor chip. Favorably, all or part of the image data memory 111, are also integrated on a same semiconductor chip.

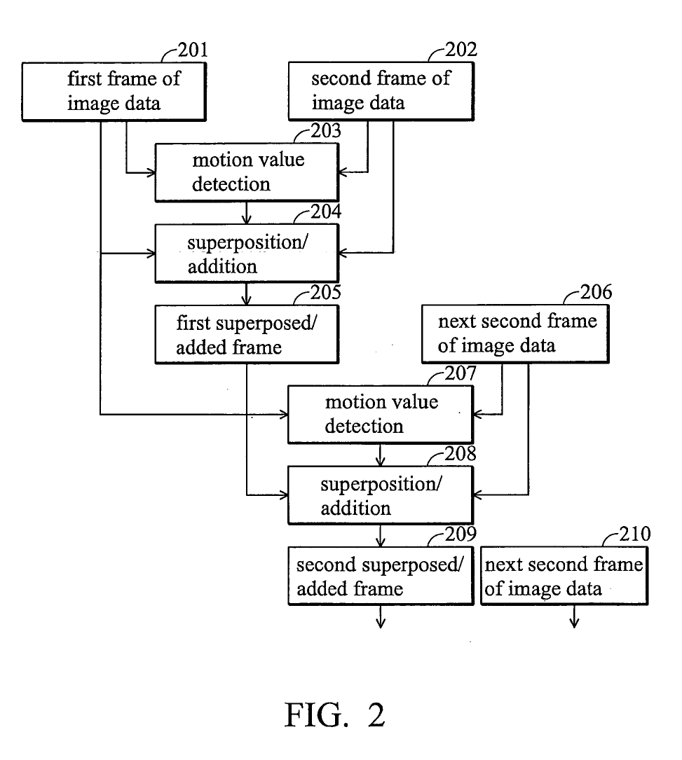

FIG. 2 shows a basic flow diagram of a superposition/addition operation in the image capturing system 100. Referring to FIGS. 1 and 2, a superposition/addition operation of the image capturing system 100 will be described in detail. At step 201, a first frame of image data is stored in an image data memory 111. At step 202, a second frame of image data is stored in the image data memory 111. At step 203, a motion value between the first frame of image data and the second frame of image data is detected in the motion detection block 110. At step 204, the second frame of image data is superposed/added to the first frame of image data shifting in reverse direction of said motion value in the superposition/addition block 106, and a first superposed/added frame of image data is produced.

Next, at step 205, the first superposed/added frame of image data is stored in the image data memory 111. At step 206, next second (third) frame of image data is stored in the image data memory 111. At step 207, a motion value between the first frame of image data and the next second frame of image data is detected in the motion detection block 110. At step 208, the next second frame of image data is superposed/added to the first frame of image data shifting in reverse direction of said motion value in the superposition/addition block 106, and a second superposed/added frame of image data is produced.

The above superposition/addition operations are continuously repeated by predetermined numbers of second frame of image data.

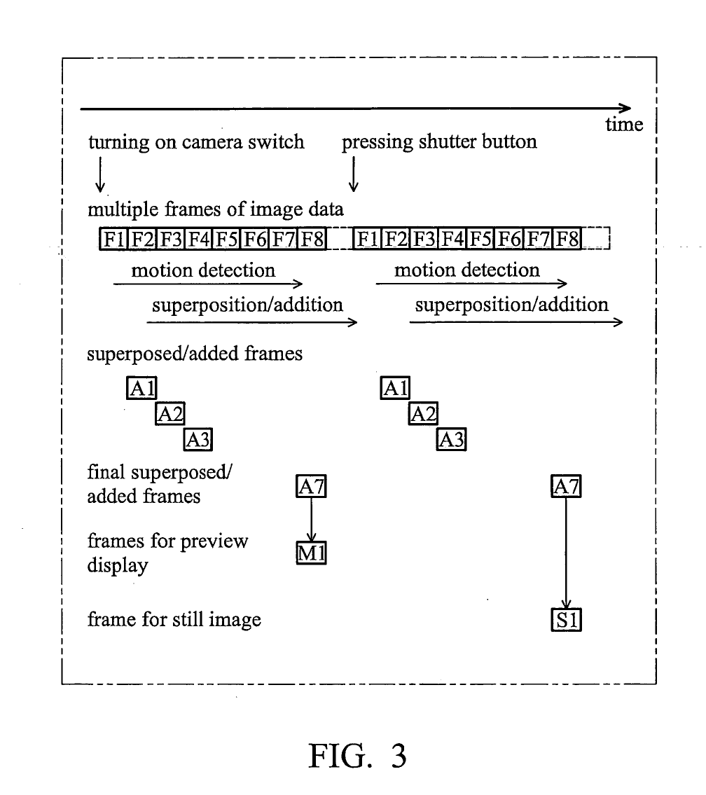

FIG. 3 shows an entire operation diagram for operating the image capturing system 100. Two typical examples of the image capturing operation will be described in detail below.

Referring right side of the FIG. 3, a still image capturing operation will be described. The still image capturing operation is started by pressing a shutter button. An exposure time in the still image capturing is shorter than a normal exposure time. Multiple frames of image data (F1 to F8 in FIG. 3) captured by the image sensor 104 are output to the motion value detection block 110 and the superposition/addition block 106. According to the above basic flow diagram of superposition/addition operation shown in FIG. 2, each motion value between first frame of image data and each second frame of image data is detected in the motion value detection block 110. Each second frame of image data is superposed/added to the first frame of image data or a prior superposed/added frame of image data shifting in reverse direction of the motion value in the superposition/addition block 106. The superposed/added frames of image data are temporally stored in image data memory 111.

The number of second frames of image data is determined according to the light intensity of the object image. In case of FIG. 3, the number of second frames of image data is 7. If the light intensity is lower, the numbers of second frames of image data is increased. A final superposed/added frame of image data (A7 in FIG. 3) stored in the image data memory 111 is sent to a storage media 109 and saved as a final still image data (S1 in FIG. 3).

Referring left side of the FIG. 3, a preview image displaying operation will be described. The preview image displaying operation is started by turning on a camera switch. Multiple frames of preview image data (F1 to F8 in FIG. 3) captured by the image sensor 104 are output to the motion value detection block 110 and the superposition/addition block 106. A frame rate in the preview image capturing is a normal frame rate, such as 30 fps. A frame size in the preview image capturing is favorably reduced by ½ to ⅛ in comparison with a frame size of normal still image. According to the above basic flow diagram of superposition/addition operation shown in FIG. 2, each motion value between first frame of image data and each second frame of image data is detected in the motion value detection block 110. Each second frame of image data is superposed/added to the first frame of image data or a prior superposed/added frame of image data shifting in reverse direction of the motion value in the superposition/addition block 106. The superposed/added frames of image data are temporally stored in image data memory 111.

The number of second frames of image data is determined according to the light intensity of the object image. In case of FIG. 3, the number of second frames of image data is 7. If the light intensity is lower, the numbers of second frames of image data is increased. Multiple final superposed/added frames of image data (multiple A7 in FIG. 3) stored in the image data memory 111 are sent to preview image display 112 and are displayed as moving preview image (multiple M1 in FIG. 3). In this case, a frame rate of preview image displaying is decreased by 30/8=3.7 fps, in comparison with the frame rate of preview image capturing, which practically causes no problem.

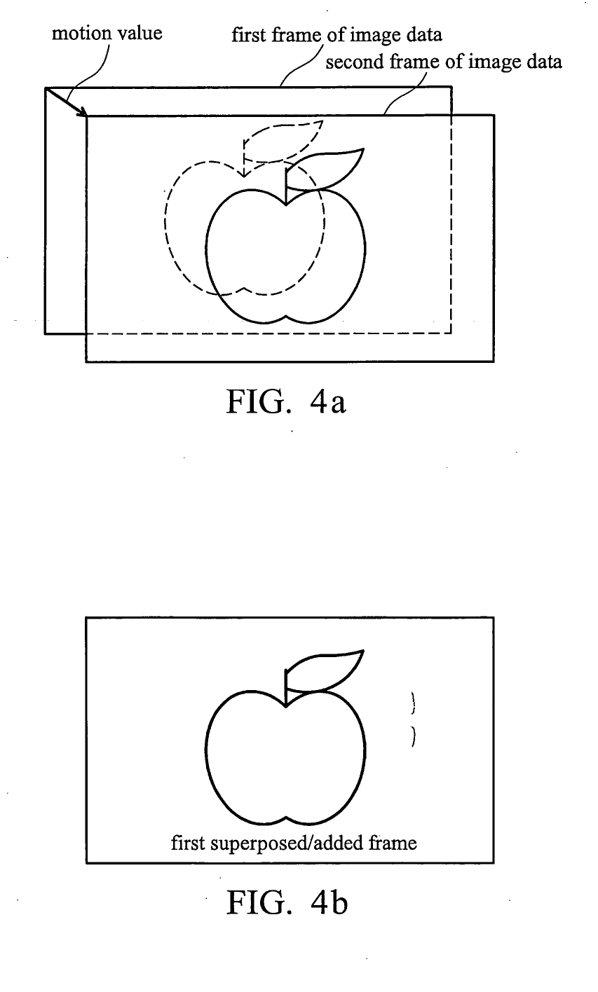

FIGS. 4a and 4b show an effect when second image data frame is superposed/added to first image data frame. If camera shaking happens, image blurring is caused. In this case, second image data frame is moved from first image data frame by motion value (arrow in FIG. 4a). If second image data frame is superposed/added to first image data frame shifting by the motion value, signal level is increased by factor of 2, as well as reducing image blurring. Meanwhile, noise level is increased only by factor of √2. Therefore, signal to noise ratio is improved by factor of √2. If n second image data frames are superposed/added to first image data frame, the signal to noise ratio is improved by factor of √2n. In case of FIG. 3, the signal to noise ratio is improved by factor of √2×7.

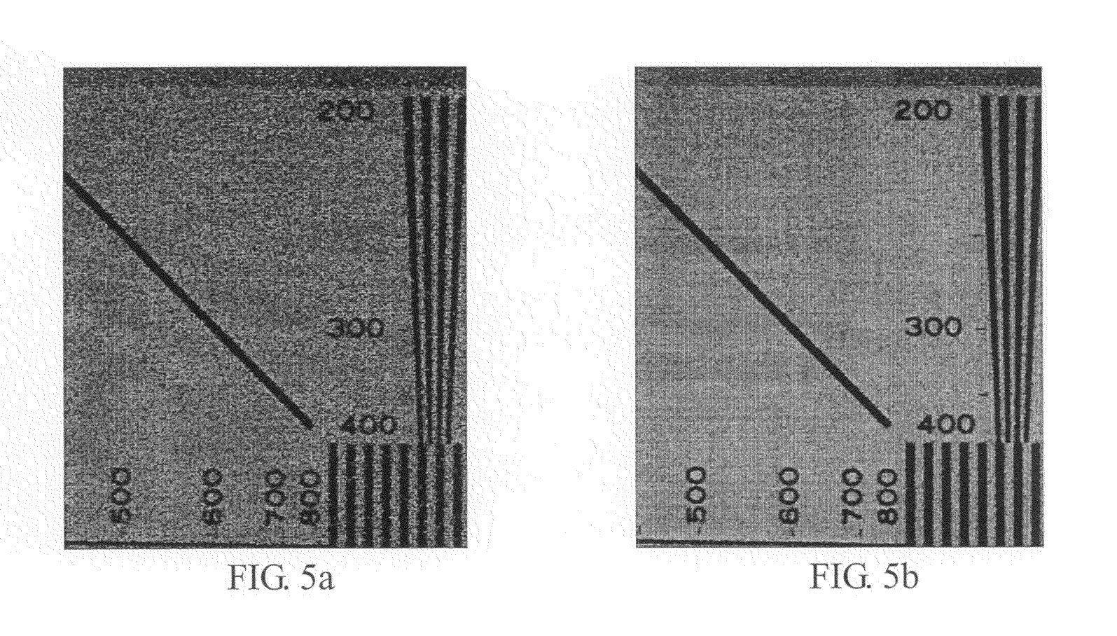

FIGS. 5a and 5b show an example of capturing an object image of ultra low light intensity (5 Lux). FIG. 5a is an image captured by a conventional digital camera adding digital gain increase process. FIG. 5b is image captured by an image capturing system according to this invention, where 10 second image data frames are superposed/added to first image data frame. It has been exemplified that a good picture quality image can be obtained even in capturing an object image of ultra low light intensity of 5 Lux.

A number of embodiments of the invention have been described. Nevertheless, it will be understood that various modifications may be made without departing from the spirit and scope of the invention. For example, the image capturing system 100 is applicable to capturing an object image of not only low light intensity but also normal or high light intensity, such as more than 500 Lux. In capturing an object image of normal or high light intensity, a clearer picture of the object image can be obtained due to reducing image blurring.

In this embodiment, an electronic motion value detection method is used, where detection point is specified on image data frame and motion value between detection point on first frame and detection point on second frame is measured. A mechanical detection method, e.g., an accelerometer can be also used.

In this embodiment, a motion value detection block 110 and a superposition/addition block 106 are configured as a hardware circuit and are integrated on a semiconductor chip. The motion value detection block 110 and the superposition/addition block 106 can be also configured using a digital signal processor including a software to operate motion value detection and superposition/addition.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image capturing system for capturing an object image of low light intensity comprising:
an image capturing means outputting a first frame and multiple second frames of object image data;
a motion value detection means receiving the first frame and the multiple second frames and detecting motion values between the first frame and each of the second frames;
a superposition/addition means superposing/adding each of the second frames to the first frame or a prior superposed/added frame which shifts in a reverse direction of the motion value;
an image data memory temporally storing image data of the superposed/added frames and sending the image data of a frame which is superposed/added by a predetermined number of second frames to a predetermined device; and
a preview image display displaying the object image prior to a still image capturing according to the image data of the superposed/added frames.

2. The system as claimed in claim 1, wherein the light intensity of the object image is smaller than 500 Lux.

3. The system as claimed in claim 1, wherein the predetermined number of second frames which are superposed/added to the first frame or the prior superposed/added frame is determined according to the light intensity.

4. The system as claimed in claim 1, wherein the predetermined device is a storage medium, and the image data of the frame which is superposed/added by the predetermined number of second frames is saved as final still image data.

5. The system as claimed in claim 4, wherein exposure time in the still image capturing is shorter than normal exposure time.

6. The system as claimed in claim 1, wherein the image data memory sends image data of multiple final frames which are superposed/added by the predetermined number of second frames to the preview image display.

7. The system as claimed in claim 6, wherein a frame rate of preview image displaying is smaller than a frame rate of preview image capturing.

8. The system as claimed in claim 1, wherein the image data memory is capable to store the image data of at least 2 frames.

9. The system as claimed in claim 1, wherein the motion value detection means and the superposition/addition means are configured as a hardware circuit and are integrated on a semiconductor chip.

10. An image capturing method for capturing an object image of low light intensity comprising:
generating a first frame and multiple second frames of object image data;
detecting motion values between the first frame and each of the second frames;
superposing/adding each of the second frames to the first frame or a prior superposed/added frame which shifts in a reverse direction of the motion value;
temporally storing image data of the superposed/added frames;
previewing the object image prior to a still image capturing according to the image data of the superposed/added frames; and
generating final still image data according to the image data of a frame which is superposed/added by a predetermined number of second frames in the still image capturing.

11. The method as claimed in claim 10, wherein the light intensity of the object image is smaller than 500 Lux.

12. The method as claimed in claim 10, wherein the predetermined number of second frames which are superposed/added to the first frame or the prior superposed/added frame is determined according to the light intensity.

13. The method as claimed in claim 10, wherein the predetermined device is a storage medium.

14. The method as claimed in claim 13, wherein exposure time in the still image capturing is shorter than normal exposure time.

15. The method as claimed in claim 10, wherein in the step of displaying the object image prior to the still image capturing, the object image is displayed according to multiple final frames which are superposed/added by the predetermined number of second frames.

16. The method as claimed in claim 15, wherein a frame rate of preview image displaying is smaller than a frame rate of preview image capturing.
